(19) United States
(12) Patent Application Publication
(10) Pub. No.: US 2017/0305806 A1
(43) Pub. Date: Oct. 26, 2017

(54) Systems, Methods, and Apparatuses for Delivering Fertilizer and Cultivating Plants

(71) Applicant: Tate Patrick Dooley, Broomfield, CO (US)

(72) Inventor: Tate Patrick Dooley, Broomfield, CO (US)

(21) Appl. No.: 15/495,918

(22) Filed: Apr. 24, 2017

Related U.S. Application Data
(60) Provisional application No. 62/326,205, filed on Apr. 22, 2016.

(51) Int. Cl. C05G 3/00; C05C 11/00

(52) U.S. Cl. CPC C05G 3/0094; C05C 11/00; C05G 3/0076

(57) ABSTRACT

Aspects of the present invention include an apparatus for delivering substances to plants, comprising a grow pod, having at least one chamber for receiving at least one substance, whereby the grow pod is dissolved in a solute to form a solution, whereby the solution is delivered to at least one plant. Aspects of the present invention include a method of delivering substances to plants, comprising the steps of using a grow pod, having at least one chamber for receiving at least one substance; dissolving the grow pod in a solute to form a solution; and delivering the solution to at least one plant. Aspects of the present invention include an apparatus for delivering substances to plants, comprising at least one substance beneficial for plant growth bound and dissolved in a solute to form a solution, whereby the solution is delivered to at least one plant.

The instant application claims priority to and the benefit of pending U.S. Provisional Patent Application Ser. No. 62/326,205, filed on Mar. 22, 2016, titled, “SYSTEMS, METHODS, AND APPARATUSES FOR DELIVERING FERTILIZER AND CULTIVATING PLANTS” the entire disclosure of which provisional application is incorporated herein by reference.

### FIELD OF THE INVENTION

Embodiments of the present invention generally relate to systems, methods, and apparatuses for delivering fertilizer and cultivating plants.

### BACKGROUND

The trials and tribulations of a plant enthusiast, whether a professional farmer entrusted with a large and valuable crop or a home garden hobbyist, are endless. Successful plant husbandry requires knowledge of the 16 major nutrients, what they do to a plant, when the plant needs them, and what the PH range should be when the nutrients are applied to plants. Growing healthy and productive plants also requires that the grower have the ability to look at the plant and see what nutrients it is lacking or if it has too much of a particular nutrient or growth enhancer. Attention must also be paid to the soil or, if applicable, hydroponic environment. Does it have the right pH or nutrients? Are these nutrients being added in the right sequence to prevent chemical reactions? Are they following the correct formula on the feed chart? What about the volume of fertilizer that is being applied? Is it too much or too little or just right? And are the fertilizer, pH and solutions being measured correctly? Further, individuals involved in professional and/or home agriculture may be exposed to inhalation of powdered fertilizer, which also creates a mess and is a safety concern for those exposed to these compounds. Still further, hand mixing fertilizer and other components is susceptible to human error, such as, for example, mixing the fertilizer batch wrong, resulting in huge economic losses.

### SUMMARY

Aspects of the present invention include an apparatus for delivering substances to plants, comprising a grow pod, having at least one chamber for receiving at least one substance, whereby the grow pod is dissolved in a solute to form a solution, whereby the solution is delivered to at least one plant.

Aspects of the present invention include a method of delivering substances to plants, comprising the steps of using a grow pod, having at least one chamber for receiving at least one substance; dissolving the grow pod in a solute to form a solution; and delivering the solution to at least one plant.

Aspects of the present invention include an apparatus for delivering substances to plants, comprising at least one substance beneficial for plant growth bound and dissolved in a solute to form a solution, whereby the solution is delivered to at least one plant.

### DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the accompanying drawings:

FIG. 1 depicts an exemplary embodiment of the present invention.

FIG. 2 depicts an exemplary embodiment of the present invention.

FIG. 3 depicts an exemplary embodiment of the present invention

FIG. 4 depicts an exemplary embodiment of the present invention.

FIG. 5 depicts an exemplary embodiment of the present invention.

FIG. 6 depicts an exemplary embodiment of the present invention.

FIG. 7 depicts an exemplary embodiment of the present invention.

FIG. 8 depicts an exemplary embodiment of the present invention.

FIG. 9 depicts an exemplary embodiment of the present invention.

### DETAILED DESCRIPTION

In one exemplary embodiment, aspects of the present invention may alleviate many of the concerns in the agriculture industry, and in one exemplary embodiment, concerns of new farmers and growers. In one exemplary embodiment, a color-coded system is used where substances such as, but not limited to, fertilizers, nutrients, supplements, inoculants, or any other substance that would aid in plant growth are delivered to a plant or plants. In one exemplary embodiment, substances are pre-dosed to the pH specific to the stage of growth of the plant. In one exemplary embodiment, an alpha-numeric system is used. In one exemplary embodiment symbols are used. In one exemplary embodiment, markings are used. In one exemplary embodiment, any type of marking or color or symbols or alpha-numeric system, or any type of marking is used where fertilizer, supplements, and/or inoculants are pre-dosed to the pH specific to the stage of growth of the plant. In one exemplary embodiment, aspects of the present invention will result in the correct application of fertilizer, supplements, and/or inoculants specific to the plant and/or the stage of growth of the plant. In one exemplary embodiment, the three most common reservoirs used are 5 gallon, 50 gallon, and 250 gallon. However, in one exemplary embodiment, applications of the preset invention may be applied to any amount of water. In one exemplary embodiment, applications of the present invention may be used depending on the number of plants that are being grown.

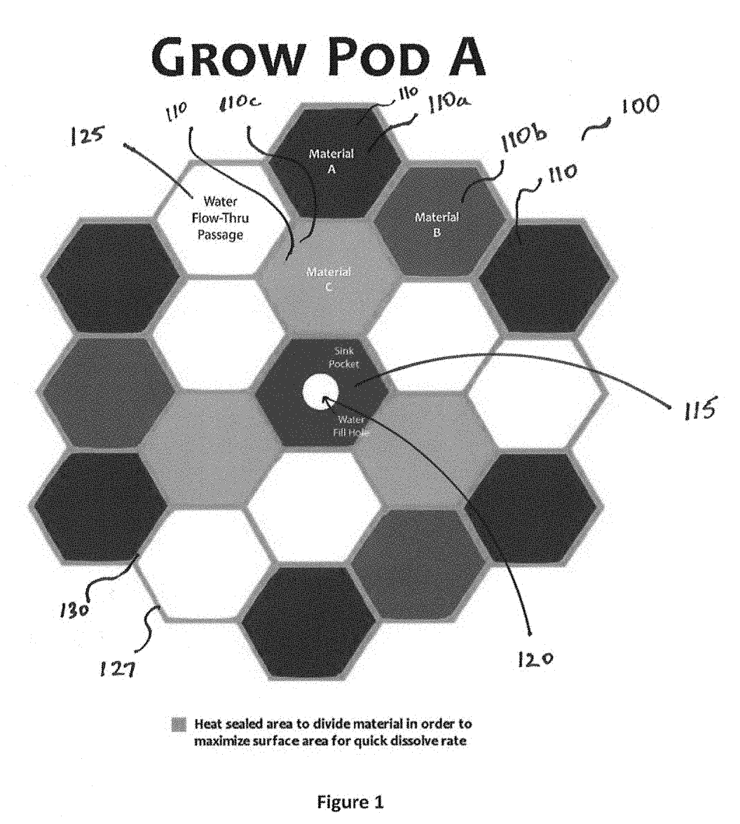

FIG. 1 depicts an exemplary embodiment of an exemplary grow pod 100 of the present invention. In one exemplary embodiment, grow pod 100 is used to dissolve in a predetermined amount of water suitable for providing substances, including but not limited to fertilizers and nutrients 110, or any other substance that would aid in plant growth, to a predetermined or undetermined number of plants. In one exemplary embodiment, grow pod 100 includes any number or combination of fertilizers and nutrients 110a, 110b, 110c that are suitable for that particular plant's growth at that stage in its life cycle. In one exemplary embodiment, fertilizers and nutrients 110 are separated from each other within grow pod 100, in chambers 127 to prevent, for example, mixing of the various fertilizers and nutrients 110 which may create internal chemical reactions amongst the various fertilizers and nutrients 110 prior to their introduction to water (not shown). In one exemplary embodiment, the thickness of chamber 127 is not limited in any way and may be wider or thinner based on the two adjacent materials. For example, if there is a higher risk of chemical interaction, a thicker chamber wall would be used. In one exemplary embodiment, the thicker the chamber materials, the longer the time that the chamber would take to dissolve and the nutrients would interact with each other in the water. In one exemplary embodiment, chambers 127 are made of water-soluble material 130 that is heat sealed to divide fertilizers and nutrients 110 in order to maximize surface area for a quick dissolve rate. In one exemplary embodiment, chambers 127 do not dissolve in water. In one exemplary embodiment, any number of chambers 127 are used to create grow pod 100 depending on that specific plant's nutritional requirements and stage of its growth. As a result, for example, grow pod 100 may be designed in any known or unknown geometric or non geometric shape. In one exemplary embodiment, grow pod 100 may include a sink packet 115 so that grow pod 100 can sink to the bottom of the water source, such as a container of water or a weight (not shown). In one exemplary embodiment, sink packet 115 contains a water fill hole 120. In one exemplary embodiment, grow pod 100 also contains a water flow through passage 125. In one exemplary embodiment, different fertilizers and nutrients 110 dissolve at different rates in water (not shown).

1. Volume of Fertilizer

Typically, plants need different volumes of fertilizer for different stages of plant growth. In one exemplary embodiment, for example, a plant may use fertilizer and nutrient “Material A” 110a at the rate of 1 oz per gallon of solution at week 2 of growth. Then later in that same plant's life, it may use fertilizer and nutrients “Material A” 110a at the rate of 2 oz per gallon of solution at week 6 of plant growth. Aspects of the present invention permit a grower to use grow pod 100 with premixed and preformulated amounts of minerals and nutrients for a specific type of plant, for its specific stage in the plant's growth cycle.

2. Formulation of Fertilizer—

Typically, plants need different formulations of fertilizer and nutrients 110 for different stages of plant growth. In one exemplary embodiment, for example, grow pod 100 in Stage 1 may be dominant in Nitrogen @ week 2 of plant growth and the plant may need that formula to have a pH range of 6.5. Then later in the same plant's life, grow pod 100 in Stage 2 may be dominant in phosphorus @ week 6 of the plant growth and the plant may need that formula to have a pH range of 5.3. However, in one exemplary embodiment, various stages of plant growth formulas and predetermined/measured pH ranges are combined using, for example, a color-coded, alpha-numeric system or other symbol, or any combination thereof, for easy identification. As a result, in on exemplary embodiment, the consumer can have a new tailored fertilizer formulation and desired pH for every stage of plant growth. In one exemplary embodiment, using aspects of the present invention will be as easy as adding, for example, the color coded or numbered grow pod 100 or multiple grow pods 100 for desired feed that match the particular plant growth stage to the applicable volume of water and applying same to the plant. Previously, the user would have to have multiple bottles or products and perform a lot of measuring and calculating to achieve the desired formula for that certain stage of plant growth. Aspects of the present invention enable a grower to use grow pod 100, for example marked with an “A” or “1” or a specific exemplary color such as, for example, “white,” or a specific exemplary shape such as, for example, a “ball” or any other three dimensional shape during the first stage of the plant's growth. The grower would simply dissolve grow pod 100 in a predetermined amount of water and apply the solution to a predetermined number of plants. Once the plant has reached the second stage of its growth, aspects of the present invention enable a grower to use grow pod 100, for example marked with an “B” or “2” or a specific exemplary color such as, for example, “yellow,” or a specific exemplary shape, such as, for example, a “tetrahedron,” a “cube,” or any other three dimensional shape, ideal for the plant's growth. The grower would simply dissolve grow pod 100 in a predetermined amount of water and apply the solution to a predetermined number of plants. This cycle would continue throughout the plant's growth cycle.

In one exemplary embodiment, the fertilizer and/or nutrients and/or any substance beneficial for plant growth can be mixed with a binder to create different shapes for the various stages of plant growth. Binders are used to make the components stick together when the ingredients are compressed to make the pill. In one exemplary embodiment, an external retainer is not necessary because the binder forms the substance into a self-contained unit. In one exemplary embodiment, the fertilizers and/or nutrients are mixed with a binder and pressed into a three dimension shape for different concentrations/formulations such as, for example, a “multi-planer circle” or a “cylinder” for stage 1 of plant growth, a “pyramid” for stage 2 of plant growth, a “cube” for stage 3 of plant growth, etc. In one exemplary embodiment, each shape represents a different stage in the growth process. In one exemplary embodiment, a three dimensional shape coupled with a color or an alphanumeric number or a marking or design is used to differentiate the fertilizer and/or nutrient combination applicable for the stage of plant growth.

In one exemplary embodiment, the fertilizer, nutrients, and/or beneficial substances are mixed with a binder and different colors for the different stages of plant growth. In one the bound substances are placed in the grow pod and are packaged in a way so that the fertilizers and/or nutrients are mixed with a binder and pressed into a three dimension shape for different concentrations/formulations such as, for example, a “multi-planer circle” or a “cylinder” for stage 1 of plant growth, a “pyramid” for stage 2 of plant growth, a “cube” for stage 3 of plant growth, etc. In this exemplary embodiment, the grow pod acts as a further buffer protecting the bound tablet from humidity and other environmental issues. In this exemplary embodiment, each shape represents a different stage in the growth process. In another exemplary embodiment, a three dimensional shape coupled with a color or an alphanumeric number or a marking or design is used to differentiate the fertilizer and/or nutrient combination applicable for the stage of plant growth.

The liability with the previous method is that the user may not be paying attention and may add the fertilizer in the wrong sequence or volume, which can cause a negative chemical reaction and render the fertilizer useless or even harmful to a valuable crop. In one exemplary embodiment, fertilizers are placed in pod compartments next to each other in water soluble separate heat-sealed pockets 130. This will further ensure that poor chemical reactions do not occur. This is a further aspect of the present invention.

3. Design of Grow Pod 100

In one exemplary embodiment, certain fertilizers and nutrients 110 may be “hydro-phobic”. By incorporating a special design of pod that may or may not have holes/passageways/thinner areas of film or waffle/honeycomb indentations or passageways, in any shape or design, the hydro-phobic action of a particular fertilizer can be overcome. In one exemplary embodiment, instead of having 1 pouch with all of the material gathered into one area (that may not dissolve easily/quickly or dump together), aspects of the present invention include a waffle or honeycomb (or any other shape) design of chambers 127 and grow pod 100, that take smaller amounts of fertilizers and nutrients 110 powder and surround it with permeated holes or passages in the pod (not shown) can be used to allow water onto that particular surface area. The pod can be shaped to speed up the dissolve rate and also allow maximum surface area of water to product. This shape could also be designed according to the most common bag size and or customer fertilizer mixing tank.

In one exemplary embodiment, the shape of the grow pod 100 can take on an infinite amount of shapes, sizes, volumes, formulas, and pH ranges. In one exemplary embodiment, fertilizer and nutrients 110 within grow pod 100 can be anything from fertilizer (powder, granular gel, liquid or a combination), biological inoculants, supplemental fertilizer, carbon based fertilizers, chemical based fertilizers, nanotechnology fertilizer, herbicides to pesticides. Any of these can come in powder or granular or liquid or gel form. It is also possible to do a combination of any of the above products in any form of liquid, gel, powder, granular or a combination of liquid, gel, powder and granular.

In one exemplary embodiment, grow pods 100 may be fabricated/manufactured without the dissolvable film by simply pressing the material together under pressure when sufficient binder content is present, or by adding a dissolvable binder and then applying the pressure to form the grow pod 100 or tablet, and accurately provide the user with premeasured amounts of fertilizer.

4. Sink Pocket/Pouch 115

Certain fertilizers, due to their density, have a tendency to float. In one exemplary embodiment, by incorporating sink pocket 115 into the grow pod 100, grow pod 100 easily submerge to the bottom of the reservoir (not shown) where the customer is mixing the fertilizer. In one exemplary embodiment, sink pocket 115 could also be a pouch with a weight in it to assist sinking action. This will also allow hydro-phobic materials to permeate surface tension and dissolve better/faster. When hydro-phobic materials float to the top of a container of water, they have difficulty mixing into the water or solution. In one exemplary embodiment, sink pocket or pouch 115 will allow a small portion of the grow pod 100 to have a weighted material or to fill with water increasing the weight of the grow pod and assisting it to sink. In one exemplary embodiment, sink pocket or pouch 115 can have one or more sink holes 120 on any surface of sink pocket 115. In one exemplary embodiment, sink pocket 115 can have multiple sink holes 120 on multiple sides. In one exemplary embodiment, sink pocket or pouch 115 can be any size depending on how much weight or water the given size of pod needs to displace to allow grow pod 110 to sink.

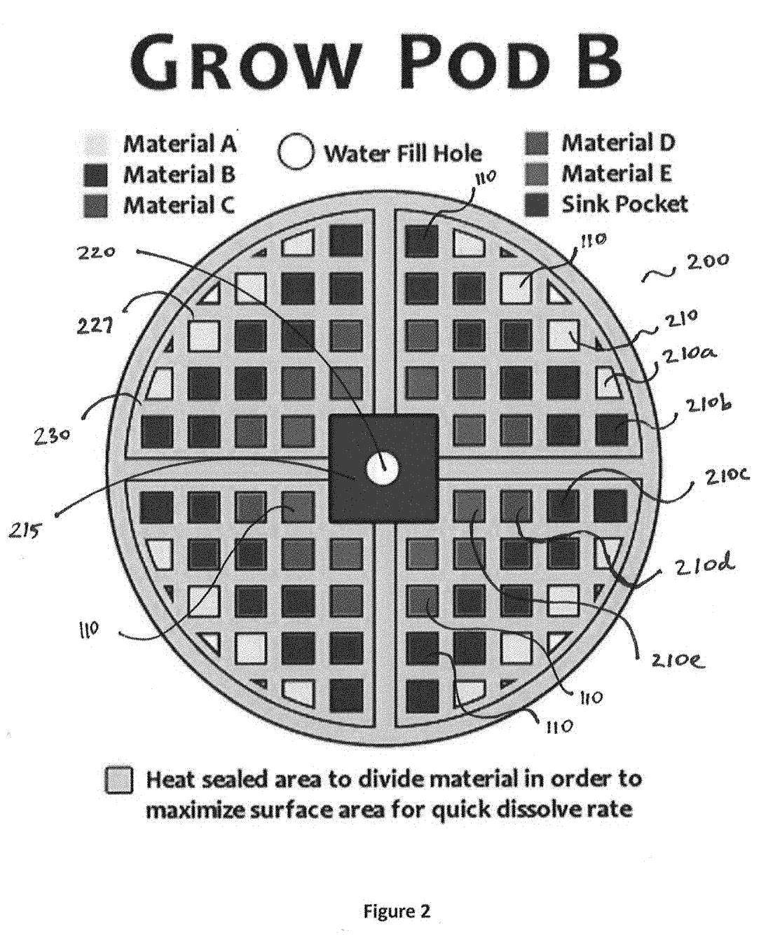

FIG. 2 depicts an exemplary embodiment of an exemplary grow pod 200 of the present invention. In one exemplary embodiment, grow pod 200 is designed in a waffle shape to dissolve in a predetermined amount of water suitable for providing a number of fertilizers and nutrients 210 (here, shown for example, as 210a, 210b, 210c, 210d, and 210e) to a predetermined number of gallons of water or plants, suitable for that plant(s)' growth at that stage in its life cycle. In one exemplary embodiment, fertilizers and nutrients 210 are separated from each other within grow pod 200, in chambers 227 to prevent, for example, mixing of the various fertilizers and nutrients 210, which, as discussed before, may create internal chemical reactions amongst the various fertilizers and nutrients 210 prior to their introduction to water (not shown). In one exemplary embodiment, chambers 227 are made of water-soluble material 230 that is heat sealed to divide fertilizers and nutrients 210 in order to maximize surface area for a quick dissolve rate. In one exemplary embodiment, chambers 227 do not dissolve in water. In one exemplary embodiment, any number of chambers 227 are used to create grow pod 200 depending on that specific plant's nutritional requirements and stage of its growth. In one exemplary embodiment, grow pod 200 may include a sink packet 215 so that grow pod 200 can sink to the bottom of the water source, such as a container of water (not shown). In one exemplary embodiment, sink packet 215 contains a water fill hole 220.

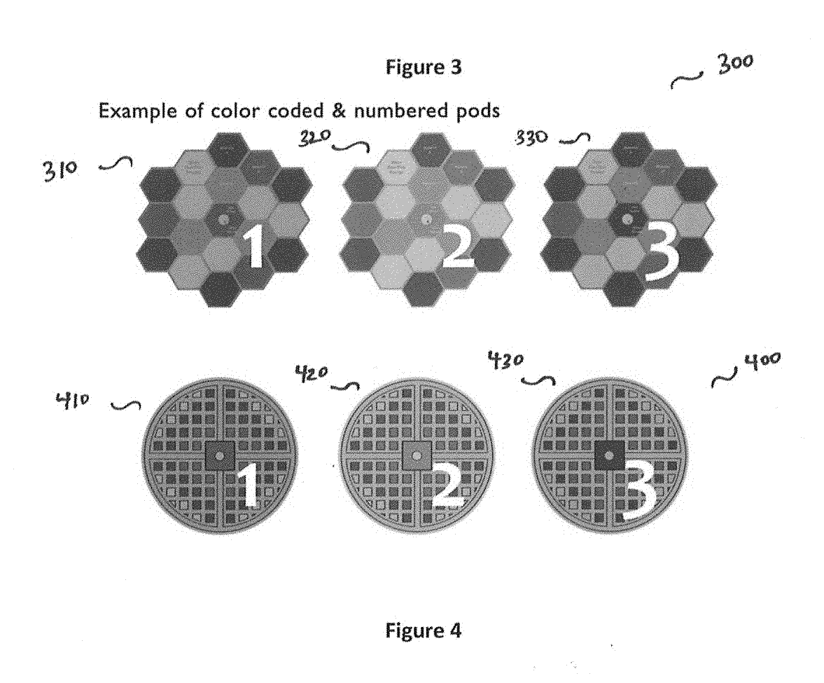

FIG. 3 depicts an exemplary embodiment of an exemplary grow pod 300 of the present invention. Three exemplary color-coded grow pods 310, 320, and 330 are shown that are used at different stages of plant growth.

5. Color Coded/Numbered for Easy Identification

In one exemplary embodiment, by incorporating a color coded, numbered, alpha-numeric, symbol, or any marking, or any of combination of the above, so that it will be very easy to identify the correct grow pod 300 needed for the desired stage of plant growth.

In one exemplary embodiment, any combination of the marking system is used. For example, the user could buy Product A (fruiting and flowering) for fruiting and flowering plants. (These plants may need different fertilizer and nutrient volumes and formulations for the multiple stages of growth a fruiting and flowering plant goes through.) As a further example, there are three (3) stages during the fruiting and flowing plant life phase, each phase needs different volume of fertilizer, formulation and Ph. range. Exemplary aspects of the present invention utilize a single product that has three (3) different grow pod in the single product package. For example, in one embodiment, each one could be identified by a numbering system for color blind people, on top of that a color coded system for people with “normal” vision.

In one exemplary embodiment, this could also be separated into a week by week or day by day mode of action. For example, the nutrient demands of certain plants change every week. For example, some plants only have 8-10 weeks of the fruiting and flowering phase. Farmers will have a short 8-10 week period to maximize the production of their crops. They may choose to change the feeds that their plants get weekly or even daily.

### Example

“Stage 1” 310 (weeks 1-3 of plant growth)=Blue GROW POD labeled with a #1
“Stage 2” 320 (weeks 4-6 of plant growth)=Green GROW POD labeled with a #2
“Stage 3” 330 (weeks 7-10 of plant growth)=Red GROW POD labeled with a #3

FIG. 4 depicts an exemplary embodiment of an exemplary grow pod 400 of the present invention. Three exemplary color-coded grow pods 410, 420, and 430 are shown that are used at different stages of plant growth.

### Example

“Stage 1” 410 (weeks 1-3 of plant growth)=Blue GROW POD labeled with a #1
“Stage 2” 420 (weeks 4-6 of plant growth)=Green GROW POD labeled with a #2
“Stage 3” 430 (weeks 7-10 of plant growth)=Red GROW POD labeled with a #3

Again, the colors and alpha-numeric symbols used in FIG. 4 are exemplary embodiments only, any number of color coded, numbered, alpha-numeric, symbol, or any marking, or any of combination of the above, can be used to identify the correct grow pod 400 needed for the desired stage of plant growth.

6. Sizes of Row Pod—

In one exemplary embodiment, to suit the various sizes of a customer's fertilizer mixing tank, aspects of the present invention include four (4) sizes premeasured for the most common “reservoir” sizes; 1 Gallon, 5 Gallon, 50 Gallon, 250 gallons. However, if, for example, if the user has a different size of reservoir than the said sizes you can “double or triple up” example, if the user has a 100-gallon reservoir the user can use 2×50 gal “GROW POD” for the desired feed rate. There may be more sizes in the future.

In one exemplary situation, there may be many different sizes of fertilizer mixing tanks with a variable amount of plants that need to be treated. In one exemplary embodiment, aspects of the present invention allow for the most common fertilizer mixing tank sizes. In one exemplary embodiment, if users do not have that exact same size fertilizer mixing tank they can “double or triple up” on any of the pod sizes offered in order to get the desired feed solution volume.

Customer example needs
3-gallon mix tank=3 qty 1 gal GROW POD
10-gallon mix tank=2 qty 5 gal GROW POD
20-gallon mix tank=4 qty 5 gal GROW POD
50-gallon mix tank=1 qty 50 gal GROW POD
100-gallon mix tank=2 qty 50 gal GROW POD
250-gallon mix tank=1 qty 250 gal GROW POD
1000-gallon mix tank=4 qty 250 gal GROW POD

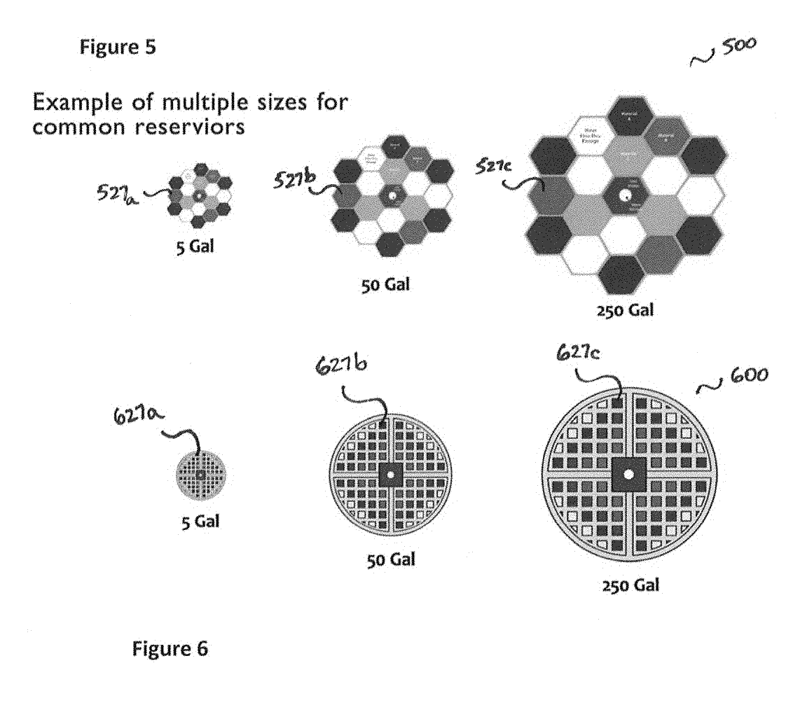

FIG. 5 depicts an exemplary embodiment of an exemplary grow pod 500 of the present invention. In one exemplary embodiment, the size of the individual chambers 527 increase depending on the application size, 527a, 527b, and 527c. For example, the size of each chamber 527a may increase 10 fold (10×) from a 5 gallon application in comparison to a chamber 527b in a 50 gallon application. As a further example, the size of chamber 527a may increase 50 fold (50×) from a 5 gallon application to the chamber 527c of a 250 gallon application. In one exemplary embodiment, the gallon size is not limited in any way.

Alternatively, in one exemplary embodiment, the size of each chamber 527 does not increase, but rather, the number of chambers may be increased. For example, if a certain fertilizer and nutrient in a 5 gallon application appears 4 times, then in a 50 gallon application, the same fertilizer and nutrient may appear 40 times. In one exemplary embodiment, the number of chambers are not limited in any way.

FIG. 6 depicts an exemplary embodiment of an exemplary grow pod 600 of the present invention. In one exemplary embodiment, the size of the individual chambers 627a, 627b, and 627c increase depending on the application size. For example, the size of each chamber 627a may increase 10 fold (10×) from a 5 gallon application to a chamber 627b of a 50 gallon application. As a further example, the size of chamber 627a may increase 50 fold (50×) from a 5 gallon application to a chamber 627c of a 250 gallon application. In one exemplary embodiment, the size of the chamber is not limited in any way.

In one exemplary embodiment, aspects of the present invention include a grow pod including fertilizers and nutrients that are applied to a plant over a time scale. In one exemplary embodiment, the grow pod is placed in a predetermined amount of water or liquid source to allow the fertilizers and nutrients to dissolve in the water or liquid source. In another exemplary embodiment the grow pod is placed directly at the root ball or at the base of the plant and no water or liquid dissolution is needed.

Plants need eighteen (18) essential elements for normal growth. Carbon, hydrogen, and oxygen are found in air and water. Nitrogen, phosphorus, potassium, magnesium, calcium, and sulfur are found in the soil. The latter six elements are used in relatively large amounts by the plant and are called macronutrients. There are nine other elements that are used in much smaller amounts; these are called micronutrients or trace elements. The micronutrients, which are found in the soil are iron, zinc, molybdenum, nickel, manganese, boron, copper, cobalt, and chlorine. All 18 elements, both macronutrients and micronutrients are essential for plant growth. Most of the nutrients that a plant needs are dissolved in water and then absorbed by the rootsln one exemplary embodiment, the ingredients used in grow pods are adjusted for indoor plants. In one exemplary embodiment, the ingredients used in grow pods are adjusted for outdoor plants. In one exemplary embodiment, the ingredients used in grow pods are adjusted to reflect the environment of the plant, such as, for example, altitude, exposure to light quality, exposure to light quantity, exposure to light duration, temperature, soil conditions, and other factors.

In one exemplary embodiment, aspects of the present invention may be used to provide supplements to plants. In one exemplary embodiment, if a plant requires, for example, additional doses of nitrogen, aspects of the present invention enable a predetermined amount of nitrogen supplement for each stage of plant growth. For example, for diluting in 50 gallons of water, for supplementation over a time period, such as, for example, eight (8) weeks, a “Nitrogen Supplement Pod” containing, for example 50 grams of supplement for “Phase 1” would be identified by either color, alphanumeric character, design, or three dimensional shape, or any other method discussed herein, so that the user would simply dissolve the supplement pod in water and apply to the plants. In one exemplary embodiment, the amount of supplement necessary is provided in the supplement pod so that the grower would not need to modify it any way. The below table provides an exemplary supplement schedule:

Nitrogen Supplement Pod—Exemplary Table (Treating 50 gallons of water)
Week 1—Nitrogen Supplement Pod (50 grams)
Week 2—Nitrogen Supplement Pod (60 grams)
Week 3—Nitrogen Supplement Pod (70 grams)
Week 4—Nitrogen Supplement Pod (80 grams)
Week 5—Nitrogen Supplement Pod (90 grams)
Week 6—Nitrogen Supplement Pod (90 grams)
Week 7—Nitrogen Supplement Pod (80 grams)
Week 8—Nitrogen Supplement Pod (70 grams)

In another exemplary embodiment, multiple pods for the same gallon of treatment, but a fixed amount of supplement provide the grower with the flexibility of creating the desired amount of supplement necessary for a particular stage of plant growth. The below table provides an exemplary supplement schedule:

### Nitrogen Supplement Pod—Exemplary Table (Treating 50 Gallons of Water)

Week 1-2 Nitrogen Supplement Pods @25 grams
Week 2-2 Nitrogen Supplement Pods @25 grams
Week 3-3 Nitrogen Supplement Pods @25 grams
Week 4-3 Nitrogen Supplement Pods @25 grams
Week 5-4 Nitrogen Supplement Pods @25 grams
Week 6-3 Nitrogen Supplement Pods @25 grams
Week 7-2 Nitrogen Supplement Pods @25 grams
Week 8-2 Nitrogen Supplement Pods @25 grams

In one exemplary embodiment, a supplement may be a pH adjuster. This exemplary supplement would permit a grower to continue to use their existing fertilizers and nutrients and adjust the necessary pH with a pH Pod. In one exemplary embodiment, pH can be adjusted with increments of citric acid per gallon of water.

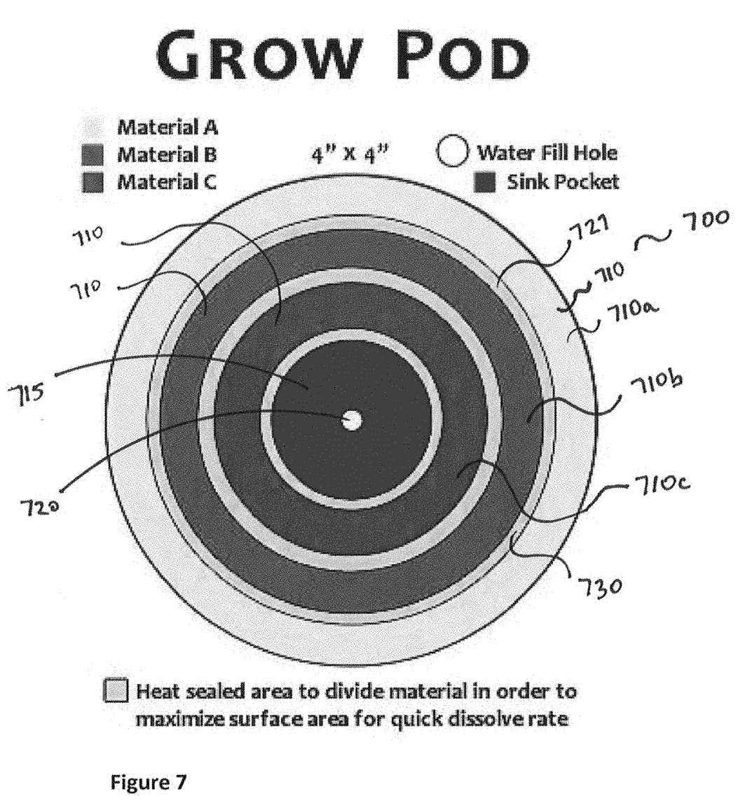

FIG. 7 depicts an exemplary embodiment of an exemplary grow pod 700 of the present invention. In one exemplary embodiment, grow pod 700 is designed in a ‘target’ shape to dissolve in a predetermined amount of water suitable for providing a number of fertilizers and nutrients 210 (here, shown for example, as 710a, 710b, and 710c) to a predetermined number of gallons of water or plants, suitable for that plant(s)' growth at that stage in its life cycle. In one exemplary embodiment, fertilizers and nutrients 710 are separated from each other within grow pod 700, in one or more chambers 727 to prevent, for example, mixing of the various fertilizers and nutrients 710, which, as discussed before, may create internal chemical reactions amongst the various fertilizers and nutrients 710 prior to their introduction to water (not shown). In one exemplary embodiment, chambers 727 are made of water-soluble material 730 that is heat sealed to divide fertilizers and nutrients 710 in order to maximize surface area for a quick dissolve rate. In one exemplary embodiment, chambers 727 do not dissolve in water. In one exemplary embodiment, any number of chambers 727 are used to create grow pod 700 depending on that specific plant's nutritional requirements and stage of its growth. In one exemplary embodiment, grow pod 700 may include a sink packet 715 so that grow pod 700 can sink to the bottom of the water source, such as a container of water (not shown). In one exemplary embodiment, sink packet 715 contains a water fill hole 720.

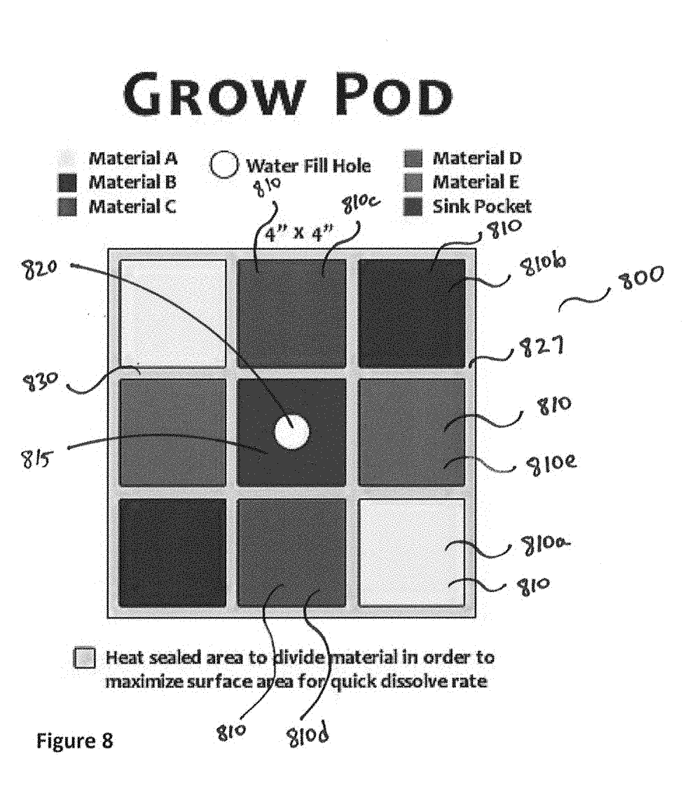

FIG. 8 depicts an exemplary embodiment of an exemplary grow pod 800 of the present invention. In one exemplary embodiment, grow pod 800 is designed in a ‘square’ shape to dissolve in a predetermined amount of water suitable for providing a number of fertilizers and nutrients 810 (here, shown for example, as 810a, 810b, 810c, 810d, and 810e) to a predetermined number of gallons of water or plants, suitable for that plant(s)' growth at that stage in its life cycle. In one exemplary embodiment, fertilizers and nutrients 810 are separated from each other within grow pod 800, in one or more chambers 827 to prevent, for example, mixing of the various fertilizers and nutrients 810, which, as discussed before, may create internal chemical reactions amongst the various fertilizers and nutrients 810 prior to their introduction to water (not shown). In one exemplary embodiment, chambers 827 are made of water-soluble material 830 that is heat sealed to divide fertilizers and nutrients 810 in order to maximize surface area for a quick dissolve rate. In one exemplary embodiment, chambers 827 do not dissolve in water. In one exemplary embodiment, any number of chambers 827 are used to create grow pod 800 depending on that specific plant's nutritional requirements and stage of its growth. In one exemplary embodiment, grow pod 800 may include a sink packet 815 so that grow pod 800 can sink to the bottom of the water source, such as a container of water (not shown). In one exemplary embodiment, sink packet 815 contains a water fill hole 820.

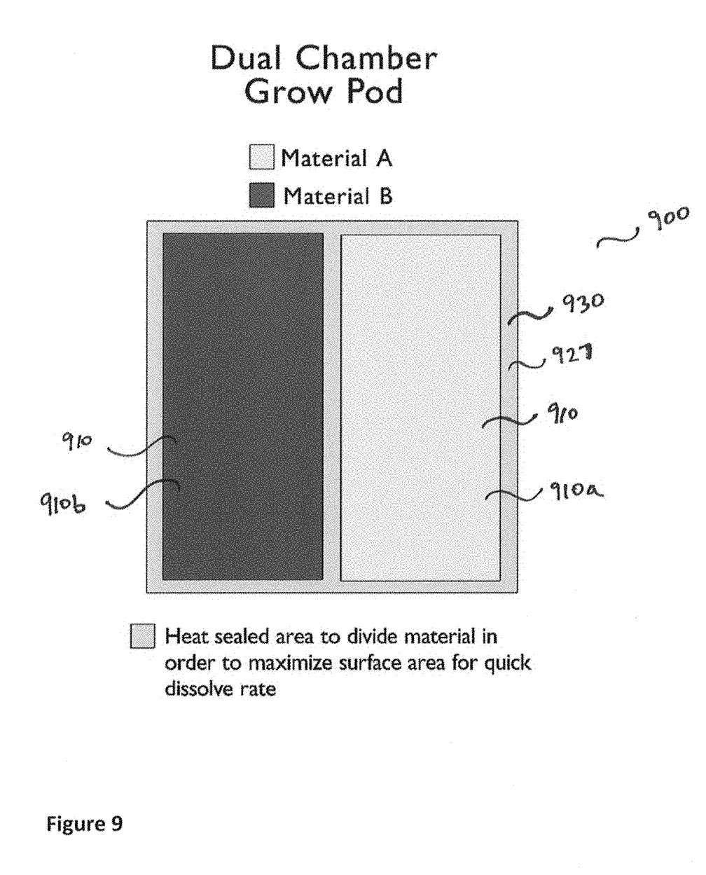

FIG. 9 depicts an exemplary embodiment of an exemplary grow pod 900 of the present invention. In one exemplary embodiment, grow pod 900 is designed in a ‘dual chamber’ shape to dissolve in a predetermined amount of water suitable for providing a number of fertilizers and nutrients 910 (here, shown for example, as 910a and 910b) to a predetermined number of gallons of water or plants, suitable for that plant(s)' growth at that stage in its life cycle. In one exemplary embodiment, fertilizers and nutrients 910 are separated from each other within grow pod 900, in one or more chambers 927 to prevent, for example, mixing of the various fertilizers and nutrients 910, which, as discussed before, may create internal chemical reactions amongst the various fertilizers and nutrients 910 prior to their introduction to water (not shown). In one exemplary embodiment, chambers 927 are made of water-soluble material 930 that is heat sealed to divide fertilizers and nutrients 910 in order to maximize surface area for a quick dissolve rate. In one exemplary embodiment, chambers 927 do not dissolve in water. In one exemplary embodiment, any number of chambers 927 are used to create grow pod 900 depending on that specific plant's nutritional requirements and stage of its growth.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art.

Throughout the specification and claims, the following terms take the meanings explicitly associated herein, unless the context dearly dictates otherwise. The phrase “In one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. An apparatus for delivering substances to plants, comprising:
a grow pod, having at least one chamber for receiving at least one substance, whereby the grow pod is dissolved in a solute to form a solution, whereby the solution is delivered to at least one plant.

2. The apparatus of claim 1, wherein the substance is selected from the group consisting of fertilizers, supplements, nutrients, minerals, inoculants, vitamins, additives, and plant food.

3. The apparatus of claim 1, wherein the solute is water based.

4. The apparatus of claim 1, wherein the chamber is made of water soluble material.

5. The apparatus of claim 1, wherein the at least one substance contained in the grow pod is specific to a growth phase of the at least one plant.

6. The apparatus of claim 1, wherein the grow pod correlates to a specific growth phase of the at least one plant.

7. The apparatus of claim 6, wherein the grow pod is marked with an alphanumeric number correlating to a specific growth phase of the at least one plant.

8. The apparatus of claim 6, wherein the grow pod is colored, correlating to a specific growth phase of the at least one plant.

9. The apparatus of claim 6, wherein the grow pod is formed in a three dimensional shape, correlating to a specific growth phase of the at least one plant.

10. The apparatus of claim 1, wherein the grow pod correlates to a fixed amount of solute.

11. The apparatus of claim 10, wherein the size of the grow pod increases proportionate to the increase of the amount of solute.

12. A method of delivering substances to plants, comprising the steps of:
using a grow pod, having at least one chamber for receiving at least one substance;
dissolving the grow pod in a solute to form a solution; and
delivering the solution to at least one plant.

13. The method of claim 12, wherein the substance is selected from the group consisting of fertilizers, supplements, nutrients, minerals, inoculants, vitamins, additives, and plant food.

14. The method of claim 12, wherein the solute is water based.

15. The method of claim 12, wherein the chamber is made of water soluble material.

16. The method of claim 12, wherein the at least one substance contained in the grow pod is specific to a growth phase of the at least one plant.

17. The method of claim 12 wherein the grow pod correlates to a specific growth phase of the at least one plant.

18. The method of claim 17, wherein the grow pod is marked with an alphanumeric number correlating to a specific growth phase of the at least one plant.

19. The method of claim 17, wherein the grow pod is colored, correlating to a specific growth phase of the at least one plant.

20. An apparatus for delivering substances to plants, comprising:
at least one substance beneficial for plant growth bound and dissolved in a solute to form a solution, whereby the solution is delivered to at least one plant.
